(19) United States
(12) Patent Application Publication
(10) Pub. No.: US 2013/0236860 A1
(43) Pub. Date: Sep. 12, 2013

(54) SYSTEM AND METHOD FOR TESTING PROGRAMMING SKILLS

(71) Applicant: Hitanshu Dewan, Rohini (IN)

(72) Inventor: Hitanshu Dewan, Rohini (IN)

(21) Appl. No.: 13/872,034

(22) Filed: Apr. 26, 2013

(30) Foreign Application Priority Data
Oct. 26, 2010 (IN) 2561/DEL/2010

(51) Int. Cl. G09B 19/00

(52) U.S. Cl. CPC G09B 19/0053
USPC 434/118

(57) ABSTRACT

The present embodiment discloses a test engine to evaluate a test taker's programming skills. The test engine includes at least one partial program logic module that defines a set of predefined conditions in relation to the solution to a problem, an input module that receives test taker input relating to the problem and an evaluation module that combines the predefined conditions and the test taker input to form a complete functionality to be evaluated and assigns a score based upon at least the correctness of the complete functionality.

The present application is a National Phase Application for PCT/IN2011/000739 which claims priority from Indian Application Number 2561/DEL/2010, filed on 26^{th} Oct., 2010, the disclosure of which is hereby incorporated by reference herein.

### TECHNICAL FIELD

The present embodiment relates to the field of test engines. More specifically, it relates to a system and method for testing a test-taker's programming skills.

### BACKGROUND

Information technology companies assess a potential test-taker for a job based on numerous skill sets like logical ability, quantitative ability, communication skills, or programming skills.

While there are many online tests available for testing a person's Logical, Verbal, Quantitative, and other aptitude skills, there are no standardized tests available for the comprehensive testing of a person's skill for the job readiness in Information Technology sector, especially positions requiring real time programming.

Testing a test-taker on real time programming ability is a crucial benchmark to gauge On-Job performance, yet no standard procedure has been followed with regards to employability assessment of technology professionals Rather, most of the online tests available test the programming ability through a series of objective questions. While this methodology can test the theoretical knowledge about a programming language, it falls short of assessing practical programming ability in a real life scenario. The theoretical questions mostly have singular correct response while the programming problems can have numerous correct solutions. More so, writing a computer program is normally an open ended problem, with different programmers solving the same problem in a different manner, with a different coding style, level of optimality etc, and checking a program for correctness, on all parameters becomes difficult, if not impossible. Thus, the key reason for the lack of such automated assessment tests is the difficulty in designing an assessment engine which can exhaustively determine the correctness, brevity, and benchmarks a human evaluator will use to determine the quality of the response to a programming problem.

### SUMMARY

The present embodiment relates to a test engine for capturing and analyzing a candidate's response to a set of objective and subjective questions relating to programming skills of the candidate. The subjective questions for the computer language testing are powered by a strong backend engine, namely test engine, which captures without limitation, the candidate's programming style, compile time and run-time errors made during the coding, ability to write a program towards a desired objective and the like. The test engine is integrated to an adaptive engine, to determine the next question, based on the correctness of the response gauged by the test engine. The test engine is powered to providing snippets of pre-coded headers and footers to the test-taker, so as to restrict him to write the code snippet solving the desired programming problem. Further, the test engine is capable of determining the correctness of the code written in response to the question, by comparing it to for example, a finite state machine, a base algorithm etc. written to capture the intent of the program.

Accordingly, the present embodiment discloses a test engine to evaluate a test taker's programming skills. The test engine includes at least one partial program logic module that defines a set of predefined conditions in relation to the solution to a problem, an input module that receives test taker input relating to the problem and an evaluation module that combines the predefined conditions and the test taker input to form a complete functionality/program to be evaluated and assigns a score based upon at least the correctness of the complete functionality/program. The predefined conditions may be static conditions or editable conditions.

In another embodiment, a method of evaluating a test-taker's performance is disclosed. The method formulates a test problem and defines at least one set of predefined conditions relating to the test problem. It then receives the inputs from the test taker relating to the problem and combines the predefined conditions and the test taker inputs to form a complete functionality/program. Lastly, it evaluates the complete functionality/program and assigns a score based upon at least the correctness of the complete functionality/program.

### BRIEF DESCRIPTION OF THE FIGURES

FIG. 1 is a functional block diagram of a system 100, according to an embodiment of the present embodiment, for evaluating a test-taker's programming skills.

FIG. 2 illustrates an exemplary embodiment of a partial program logic module 112.

FIG. 3 illustrates a method that describes the relationship of pre-code and post-code with the snippet of code entered by the test-taker in an embodiment of the present embodiment.

FIG. 4 illustrates a method that elaborates step 306 in accordance with an embodiment of the present embodiment.

FIG. 5 depicts an exemplary implementation of the present embodiment in accordance with an embodiment of the present embodiment.

FIG. 6A and 6B illustrate an exemplary method implementation of the present embodiment in a test taking environment.

FIG. 7 illustrates an exemplary method of the implementation of the present embodiment with editable pre-code and/or post-code.

### DETAILED DESCRIPTION OF EMBODIMENTS

As required, detailed embodiments of the present embodiment are disclosed herein; however, it is to be understood that the disclosed embodiments are merely exemplary of the embodiment, which can be embodied in various forms. Therefore, specific structural and functional details disclosed herein are not to be interpreted as limiting, but merely as a basis for the claims and as a representative basis for teaching one skilled in the art to variously employ the present embodiment in virtually any appropriately detailed structure. Further, the terms and phrases used herein are not intended to be limiting; but rather, to provide an understandable description of the embodiment.

The terms “a” or “an”, as used herein, are defined as one or more than one. The term plurality, as used herein, is defined as two or more than two. The terms including and/or containing, as used herein, are defined as comprising (i.e., open language). The term coupled/communicates, as used herein, is defined as connected, although not necessarily directly, and not necessarily mechanically.

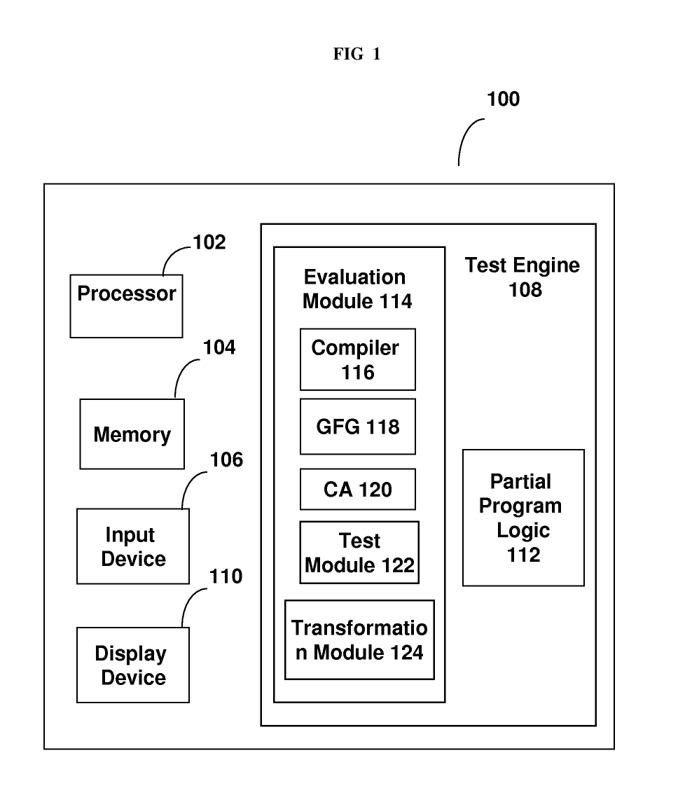

FIG. 1 is a functional block diagram of a system 100, according to an embodiment of the present embodiment, for evaluating a test-taker's programming skills. System 100 includes a processor 102 for executing software, a memory 104 (e.g., hard disk, optical disk, or other storage medium) for storing data, software, and/or other information, an input device 106 (e.g., keyboard, mouse, voice recognition device, and/or other input device) and a test engine 108. The system 100 further includes a display device 110 (e.g., monitor, liquid crystal display and/or other display device) for displaying information to the test-taker.

Test engine 108 includes a partial program logic module 112 and an evaluation module 114 which in turn may include one or more of a compiler 116, a graph flow generator (GFG) 118, a code analyzer (CA) 120 and a test module 122. In various embodiments, test engine 108 may include a single partial program logic module 112 or multiple partial program logic modules. The partial program logic modules 112 may also be referred to as precoded header/pre-code and/or precoded footer/post-code. The partial program logic module 112 includes a set of predefined conditions in relation to the solution to a problem. The predefined conditions include without limitation one or more of a function or a part of a function, a behavior, a class definition or a part of class definition, a source code, a control flow graph, a finite state machine, an object code, an interpreted code (IC), snippets of code inside function, parts of code distributed across files, or across pre-compiled software libraries. The partial program logic module 112 may be stored on memory 104 or another storage device like external memory provided with system 100. The problem includes, for example, a programming problem to be provided to the test-taker whose programming skills are to be tested.

The evaluation module 114 combines the predefined conditions, and the test-taker's input to form a complete functionality/program to be evaluated and assigns a score based upon at least the correctness of the complete functionality While assigning the score, the evaluation module 114 may further take into account brevity/quality of the test-taker's inputs, number of compilation attempts, and the like. The test-taker provides the input via the input device 110. The evaluation module 114 includes a transformation module 124 that transforms the test-taker's input to one or more of a compiled code, an interpreted code, a flow graph, an object code or an executable code. The evaluation module 114 combines this transformed form with the corresponding transformed form of the predefined conditions to form a complete functionality For example, if the test taker input is transformed to a compiled code, the evaluation module 114 combines this compiled code with the compiled version of the predefined conditions. Thereafter, the evaluation module 114 may use the compiler 116 or the graph flow generator 118 or the code analyzer 120 or the test module 122 to test the complete functionality/program. For example, compiler 116 may test the types of compile time errors, number of compile time errors made in the complete program, etc. These parameters may then be used to assign a score for the problem. Alternatively, the evaluation module 114 may use the graph flow generator 118 to generate a flow graph of the complete program, by either generating the complete flow graph of the program anew or combining the flowgraph of the test taker input with the flowgraph for the pre-code and post-code stored in the evaluation module, and then compare it with the predefined flow graph for the problem for checking the isomorphism of the complete program. Thereafter, a score to the complete program is assigned.

In yet another embodiment, the evaluation module 114 uses the code analyzer 120 to analyze the test-taker's input against a benchmark and thereafter assigns a score. Alternatively, the evaluation module 114 uses the test module 122 to test the test-taker's inputs by using the test specification and set of test functions defined for the problem. It is to be noted that the evaluation module 114 may use one or more of the four modules (116, 118, 120 or 122) to assign the score. For example, the evaluation module 114 may use the compiler 116 and the test module 122 to assign a score.

The test engine 108 may be provided with the memory 104 or an external memory that is integrated with system 100 and is executed by processor 102.

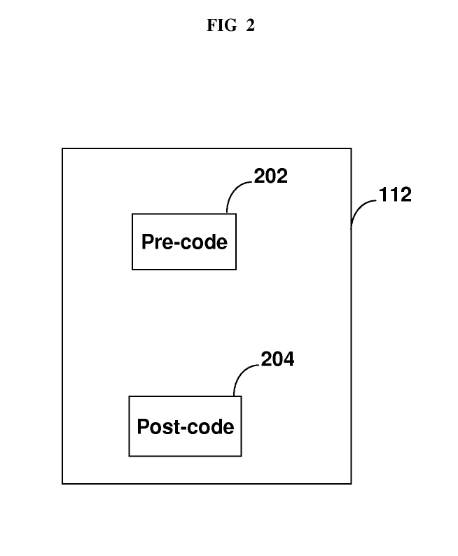

FIG. 2 illustrates an exemplary embodiment of the partial program logic module 112. The partial program logic module 112 includes a pre-code 202, and a post-code 204 enabling the test-taker to provide only a key component, of the software program, thereby, minimizing the test-taker's effort, and also enforcing a particular coding pattern. In an alternate embodiment, the partial program logic module 112 my include one of the pre-code 202 or the post-code 204. The pre-code/post-code correspond to the predefined conditions of the module 112 which may in various embodiments of the present embodiment be one or more of static conditions or editable conditions. The static conditions correspond to pre-code 202 and/or post-code 204 which are not editable by the test taker while the editable conditions correspond to pre-code 202 and/or post-code 204 which are editable by the test taker.

The pre-code 202 and post-code 204 are predetermined fragments of code that form a part of the function body that comprises the response to the programming problem in question. Also, the pre-code 202 and post-code 204 might not necessarily be a part of a programming function, but might also be a complete file or a set of files, or precompiled program libraries. This emulates closely the real life, on-job, scenario that a programmer faces where he/she has to make modifications, and insert piece of code, when the rest of the programming logic exists across multiple files, and/or pre-compiled libraries, so as to ensure that the complete program/functionality function behaves in a desired manner In various embodiments, the pre-code 202 and/or the post-code 204 may be static, thereby not editable by the test-taker or the pre-code 202 and/or the post-code 204 may be editable by the test-taker. The corresponding flow-graph and/or compiled/interpreted code of the pre-code 202 and the post-code 204 are stored in the memory 104 (or an external memory) along with problem statement. This imposition helps to restrict the variable part of the program, dynamically entered by the test-taker or the test-taker to minimal, while the crucial aspects of solving a programming problem are tested. Hence the present embodiment, through the concept of pre-code and post-code spread across a single or multiple files (and/or functions/procedures/classes/entities, based on the language and context of the program), helps emulate a real time programming problem more closely, and makes the test-taker solve a complex programming problem, which would otherwise not be possible in a limited testing framework.

In an embodiment, the problem provided to the test-taker may require multiple source-code files. In such a scenario, the pre-code 202 and/or the post-code 204 may comprise multiple source code files. While the pre-code/post-code may be static conditions, in an embodiment of the present embodiment they can be editable. Thus, one or more of the multiple source code files may be editable, while the rest of the files may be static (non-editable for the test-taker). The evaluation module 114 compiles all the files as a single program, with all the dependencies intact, thereby simulating a real-time programming environment.

The introduction of pre-code 202 and post-code 204 in the program helps make easy the evaluation of the correctness of the program on various parameters like functionality, brevity etc. This functionality enables the test engine 108 to, automatically, or through evaluator's intervention, test the required skill.

Similarly, imposing predefined conditions on the program body through pre-code and post-code, makes the evaluation of the test taker input for parameters like efficiency, execution time, memory footprints etc, counting the number of iterations of a loop etc, easier and more deterministic. This again helps the test engine 108 assess the test taker input easily, more accurately, in a better manner, and a wider range of programming problems.

The pre-code 202 and post-code 204, along with their flow-graph and/or compiled code already available, the evaluation module 114 is able to determine the isomorphism of flow-graph, and correctness of the behavior of the solution function, much more easily, and exhaustively, for a wider range of programming problems, with a lesser restriction on range and number of test-functions.

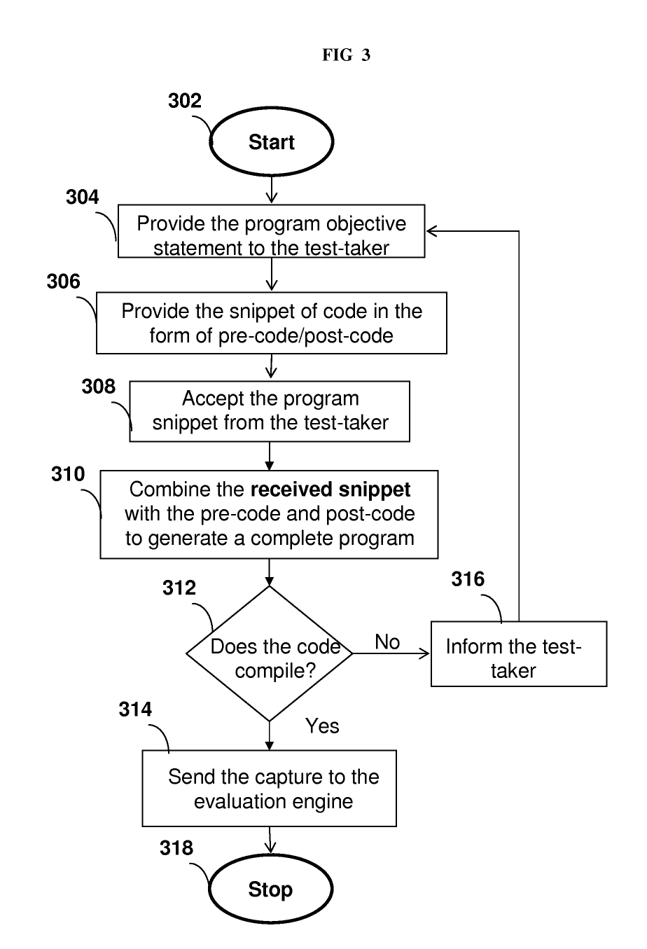

FIG. 3 illustrates a method that describes the relationship of pre-code and post-code with the snippet of code entered by the test-taker in an embodiment of the present embodiment. The method commences at 302 with the test-taker taking a test for assessment of his programming skills. The test-taker is presented a problem definition at 304 along with the pre-code and the post-code of the problem at 306. The pre-code may for example contain a main function that is presented to the test taker which he is suppose to take into account while responding to the problem. The test-taker enters his input for example a code, via the input device. Further, the test taker may select the programming language he wishes to write the program in. The method accepts the input at 308 from the test-taker. The test-taker may alter one or more files of the pre-code/post-code. Alternatively, the test-taker may not modify the pre-code/post-code. At 310, the evaluation module 114 combines the pre-code, post-code and the test-taker's input to generate a complete program. The method then compiles the complete program and checks if the program compiles successfully at 312. The compiled version of the pre-code and the post-code are already provided with the test engine. The evaluation module 114 uses these compiled versions of the pre-code and the post-code while compiling the complete program. If the program compiles, the method goes to 314 and stores the score assigned to the test-taker for the program inputted. The evaluation may also consider the number of compilation attempts, code brevity, etc. while assigning the score. However, if the program does not compile, the method informs the test-taker about the compilation error at 316. The method records the count of the failed attempt by the test-taker and also provides some hints to the test-taker with regards to the rectifying the errors. The method stops at 318.

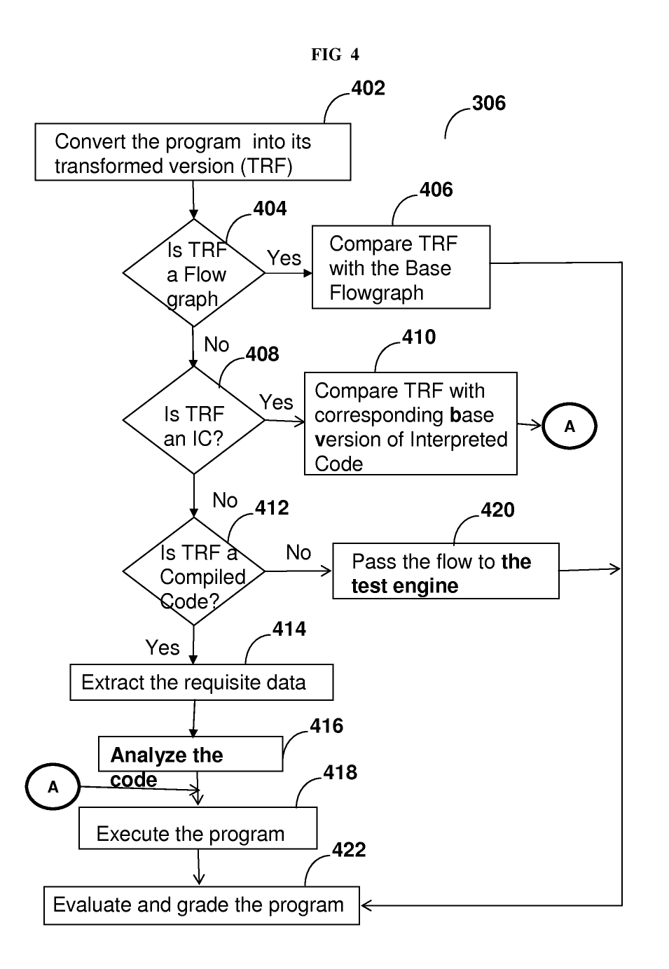

FIG. 4 illustrates a method that elaborates step 306 in accordance with an embodiment of the present embodiment. Once the test engine receives the test-taker input, it combines the pre-code, post-code and the test-taker input to form a complete program. The method converts the program into its transformed version. The transformed version comprises without limitation the corresponding flow-graph, compiled or interpreted version of the program and the like at 402. The method then checks if the transformed version is a flow-graph at 404. If the transformed version is a flow-graph, it is checked with the base flow-graph (already provide with the test engine) at 406. The properties checked include isomorphism, data flow, and control flow behavior and the like. The method then proceeds to 422.

If at 404, the method finds that the transformed version is not a flow-graph, the method checks if the transformed version is an interpreted code at 408. If the transformed version is an interpreted code, the method compares the transformed version with the corresponding base version of interpreted code at 410. The method evaluates the transformed version by running the executable in a suitable environment on a set of test-cases and checks for the desired properties and sends it for execution at 418. However, if the transformed code is not an interpreted code, the method checks if the transformed version is a compiled code at 412. If the transformed version is a compiled code, the method extracts the requisite data during compilation and sends the data and the compiled code to be checked for the desired properties at 414. The method analyzes the code using a code analyzer to find the desired properties in the code at 416. The method then proceeds to 418 for executing the program. If the transformed version is not a compiled code, the method passes the flow to the test engine to take appropriate step based on the type of the program and the transformed version at 418. The flow from 406, 418 and 420 passes to 422 where the method evaluates the correctness and does the grading of the test-taker's input.

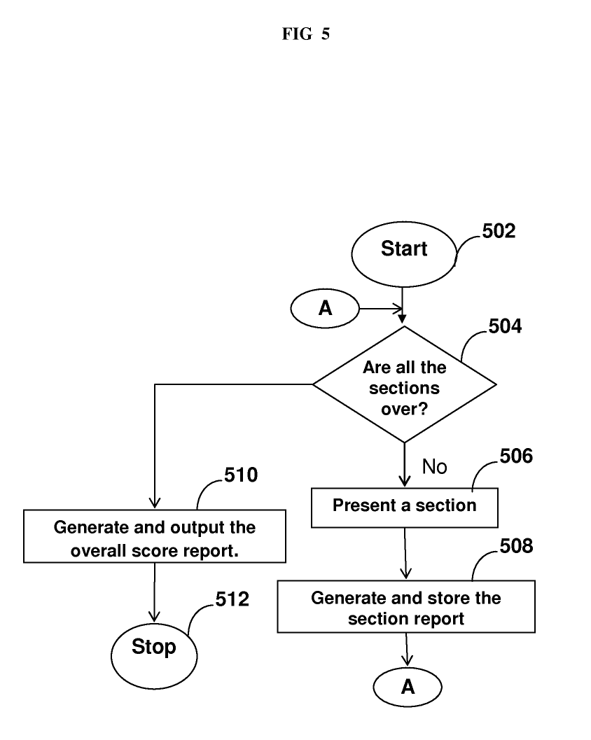

While the test engine is designed to assess the programming ability of a test-taker, it is possible to comprehensively test the aptitude or other objective ability of the test-taker. An exemplary scenario as implemented using the present embodiment is depicted in FIG. 5. At 502, the method commences the test. The test comprises of multiple sections like aptitude, programming, problem solving, and the like. At 504, the method checks if the test-taker is tested for all the sections in the test. If all the sections are not provided, the method provides a section to be tested at 506. The method provides a programming problem in one of the section to test the test-takers programming skills. The test engine tests the programming skills in an automated manner using the present embodiment defined in FIGS. 1-5. The method then moves to 508 where after receiving the test-taker's inputs, the method generates and stores the section report and jumps to 504. If the test-taker has been tested for all the sections, the method generates the overall score of the test taken by the test-taker and presents it to him at 510. It is possible that the test engine may present the next question to the test taker based upon the performance of the test taker in the previous question. The method stops at 512.

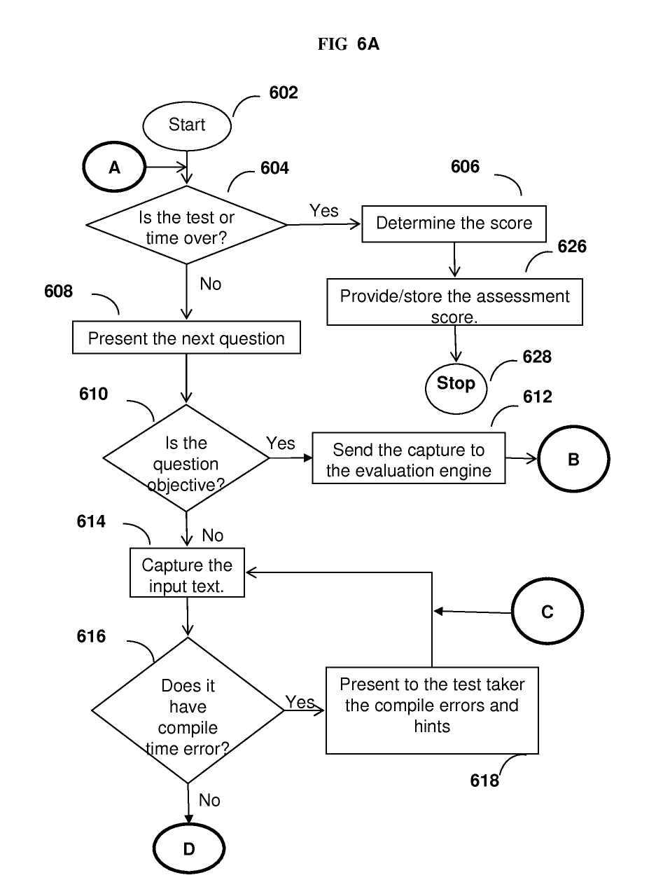

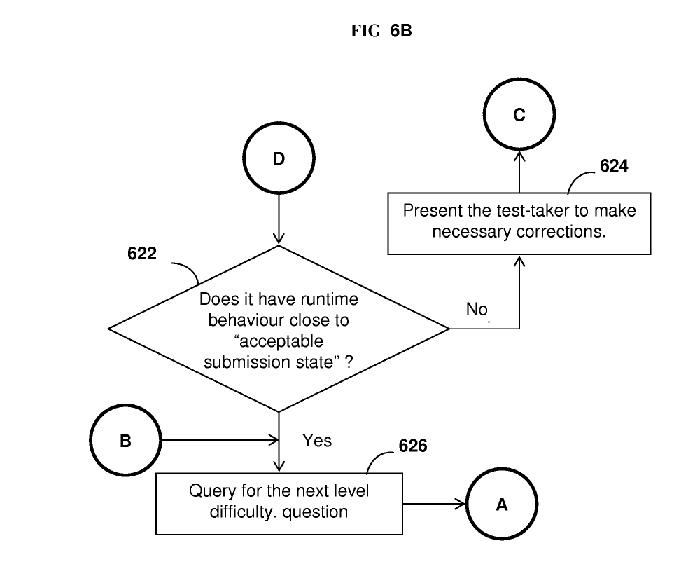

FIG. 6A and 6B illustrates an exemplary method implementation of the present embodiment in a test taking environment. The method commences at 602. At 604, the method determines if the test or the time is over. For example, if the test is timed for an hour, the method checks if one hour has lapsed. If yes, the method determines the score at 606. However, if the time is remaining, the test engine presents the next question at 608. The method checks if the question is objective at 610. If the question is objective, the method captures the response of the test-taker and sends it to the evaluation module at 612. However, if the question is subjective, the method provides the pre-code along with the post-code to the test-taker for the problem defined in the question. It is possible that one of the two is provided to the test-taker. The method captures the test-taker's response at 614 and combines it with the pre-code and the post-code to form a complete functionality The method then compiles the complete functionality and tests for compile time errors if any at 616. If compile time errors are found, the method presents the compile time errors to the test-taker with hints on correcting them at 618. The method accepts the corrections made by the test taker and sends the corrections made by the test-taker to the evaluation module at 614.

However, if the compilation is successful, the method checks if the complete functionality has runtime behaviour close to acceptable submission state, namely, as expected for the particular programming problem that was presented to the test-taker at 620. If the complete functionality is not in acceptable submission state, the method presents the previously provided input to the test-taker for correction at 622. The method joins step 614. If the complete functionality is in acceptable submission state, the method sends the complete functionality to the evaluation module and queries the test engine for the next level of difficulty question at 624. The method then goes to 604.

After 606, the method assigns a score and stores it at 626. The method finally stops at 628.

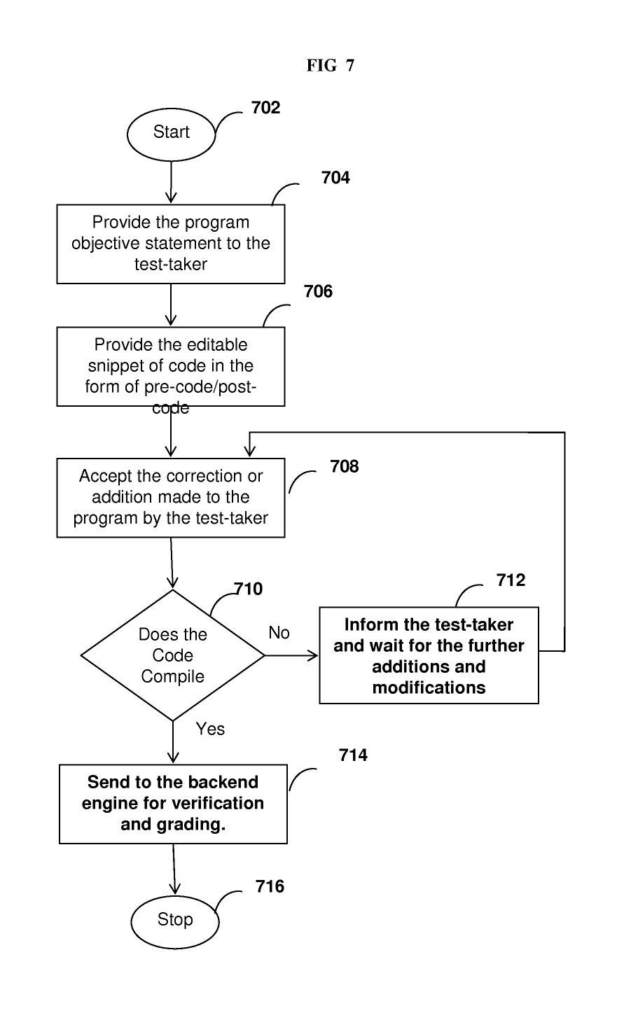

FIG. 7 illustrates an exemplary method of the implementation of the present embodiment with editable pre-code 202 and/or post-code 204. This posits a scenario where the test-taker is expected to modify a part of the pre-code or post-code and combine it with an additional piece of code to make the program perform in the desired manner The method starts at 702, and at 704, the method provides the problem statement to the test-taker. In one embodiment, the method presents a problem statement to the test taker by displaying information (e.g., text, graphics, sound, and/or other information) to the test taker that describes the problem statement's scenario and tasks that the test taker must perform to successfully complete the exercise. The problem statement may be program definition or program objective. The task may be for example, by editing the pre-code/post-code or writing a program segment. At 706, the method provides editable piece of pre-code and post-code to the test-taker, which may or may not compile, and may contain some errors towards the desired objective of the program. At 708 the method accepts the test-taker's input which may relate to modification of the pre-code or post-code, and also provide additional functionality towards the desired objective of the program. At 710, the method determines whether the program input (modifications to the pre-code/post-code as well as additional piece of code input by the test take) by the test taker compiles. For example, the test-taker may not have completely removed all the compilation errors that exist in the program input. If the program input doesn't compile, at 712, the method informs the test-taker and waits for further input and proceeds to 708, else the method sends the code for evaluation to the test engine at 714, and terminates the flow at 716.

1. A test engine comprising:
at least one partial program logic module that defines and presents to a test taker a set of predefined conditions in relation to the solution to a problem;
an input module that receives the test taker input relating to the problem; and
an evaluation module that combines the predefined conditions and the test taker input to form at least one of a complete functionality or a complete program to be evaluated, wherein the evaluation module assigns a score based upon at least the correctness of the complete functionality or complete program.

2. The test engine as claimed in claim 1, wherein the partial program logic module comprises at least one of snippets of code inside function, parts of code distributed across files, or across pre-compiled software libraries.

3. The test engine as claimed in claim 1, wherein the predefined conditions comprises one or more source code, control flow graph, finite state machine, precompiled library, object code, or interpreted code.

4. The test engine as claimed in claim 1, wherein the predefined conditions comprises one or more of static conditions and editable conditions.

5. The test engine as claimed in claim 1, wherein the evaluation module comprises a compiler to test the types and number of compile time errors.

6. The test engine as claimed in claim 1, wherein the evaluation module comprises a graph flow generator, a code analyzer and a test module.

7. The test engine as claimed in claim 1, wherein the evaluation module combines the transformed form of the predefined conditions and the test taker input.

8. The test engine as claimed in claim 7, wherein the transformed form comprises a compiled code, an interpreted code, a flow graph, an object code or an executable code.

9. The test engine as claimed in claim 1, wherein the evaluation module assigns score based upon at least the number of compilation attempts made, and code quality.

10. The test engine as claimed in claim 1, further comprising a memory comprising one or more of a transformed code, a compiled code or a flow graph for the predefined conditions.

11. The test engine as claimed in claim 1, further comprising a transformation module to transform the test taker input into one or more of a control flow graph or a compiled code.

12. A method of evaluating a test-taker's performance, the method comprising:
formulating a test problem;
defining at least one set of predefined conditions relating to the test problem;
receiving inputs from the test taker relating to the problem;
combining the predefined conditions and the test taker inputs to form at least one of a complete functionality or a complete program; and
evaluating the complete functionality or complete program and assigning a score based upon at least the correctness of the complete functionality or complete program.

13. The method as claimed in claim 12 wherein combining comprises combining the transformed version of the predefined conditions and the test taker inputs.

14. The method as claimed in claim 13 wherein the transformed version comprises one or more of a flow-graph, a compiled version or an interpreted version.

15. The method as claimed in claim 12 wherein the predefined conditions comprises one or more of a source code, a control flow graph, a finite state machine, a precompiled library, an object code, or an interpreted code.
